(19) United States
(12) Patent Application Publication
(10) Pub. No.: US 2004/0131830 A1
(43) Pub. Date: Jul. 8, 2004

(54) Protection and insulation cloth

(76) Inventors: Maximilian E. Davidson, Herzlia (IL); Yossef Raichman, Herzlia (IL); Ronen Coren, Herzlia Pituach (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/676,809

(22) Filed: Oct. 2, 2003

Related U.S. Application Data
(60) Provisional application No. 60/415,097, filed on Oct. 2, 2002.

(51) Int. Cl. B32B 3/26; B32B 27/14; B32B 5/26

(52) U.S. Cl. 428/198; 428/304.4; 442/239; 442/240; 2/243.1

(57) ABSTRACT

An insulation cloth is provided having two or more layers on top of each other and connected to each other along connecting lines forming airways between them. Gas may be provided into between the connecting lines to provide for improved insulation of the cloth.

### FIELD OF THE INVENTION

The present invention relates to the field of insulating and protecting cloths. Specifically, the invention relates to inflatable cloth that may be used for insulation or protection.

### BRIEF DESCRIPTION OF THE DRAWINGS

The subject matter regarded as the invention is particularly pointed out to an embodiment of the present invention;

FIG. 2 is a schematic cross section isometric partial view of a cloth fabric according to an embodiment of the present invention, and

FIG. 3 is a schematic illustration of another geometry for stitches according to the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

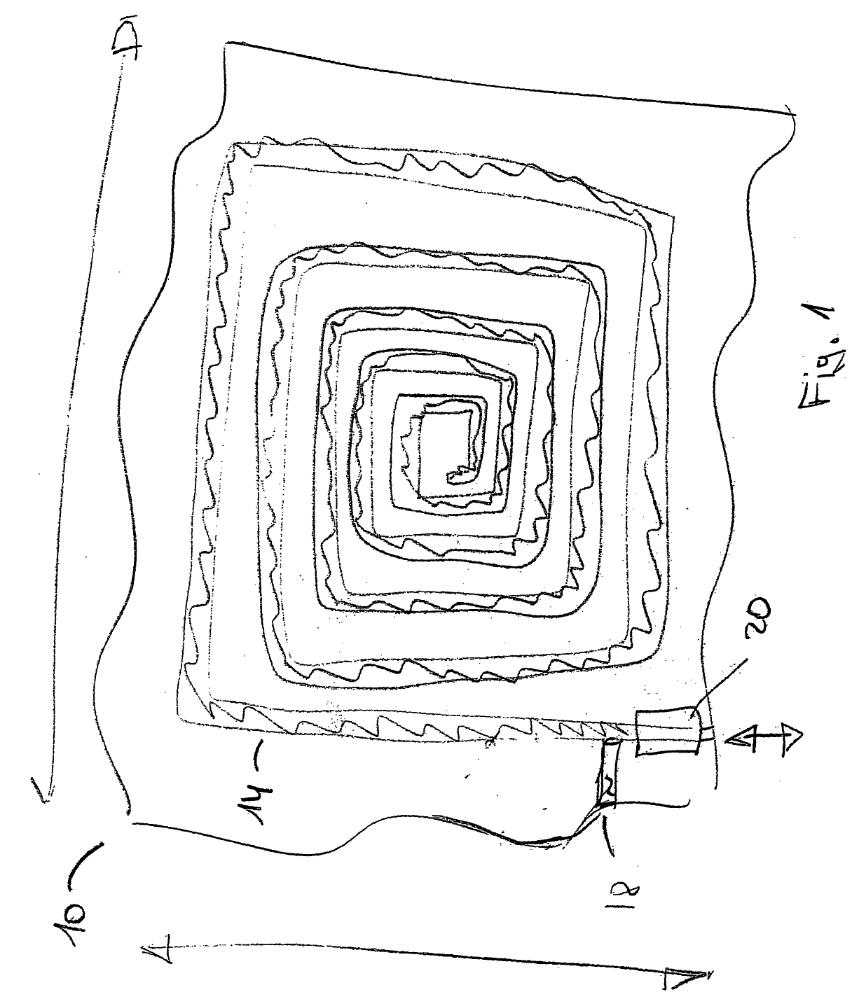

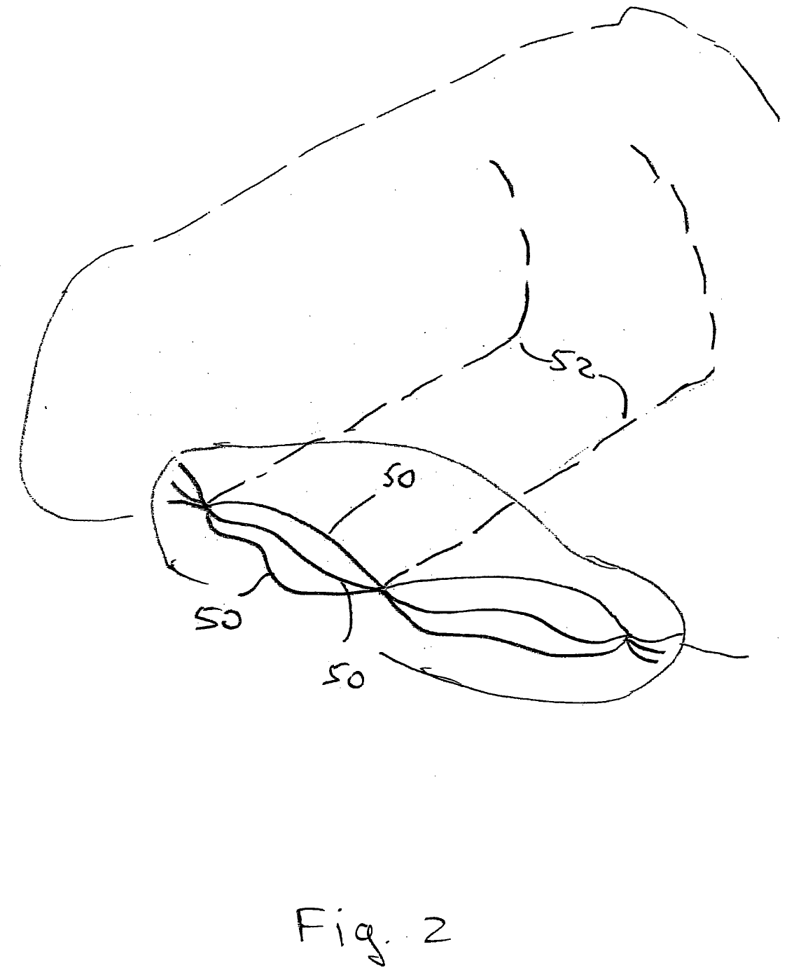

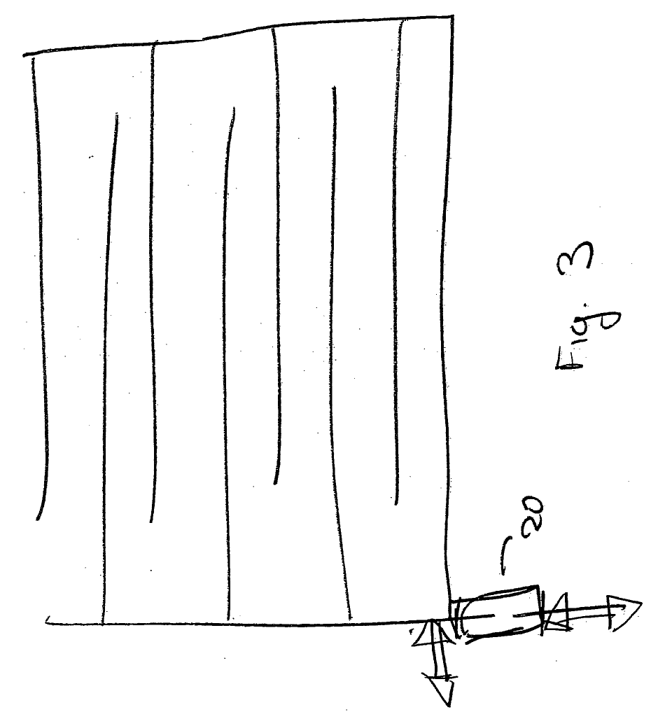

Reference is made now to FIGS. 1, 2 and 3, which are schematic illustrations of a cloth fabric 10 fabricated according to embodiments of the present invention. Cloth fabric 10 may include more than one layer of cloth 50. Said more than one layer of cloth 50 may have any desired property, such as flexibility, water repellant, breathablity, etc. Said more than one layer of cloth 50 may be connected by stitches 52 (or by any similar connecting means) to one another, and may also be sealed, so that the geometry defined between every two adjacent connection lines forms continuous passage (or airway) 14 in cloth fabric 10 (see FIG. 3). Airway 14 may have any type of geometry as long as it forms a continues airway passage. Airway 14 may have one or more inlet end 16, and one or more interconnection 18 to other airways (not shown).

Cloth fabric 10 may also comprise an integral pump 20 connected, either fixedly or removably, to cloth fabric 10 so that its outlet is in active connection with inlet end(s) 16 of airway 14. Pump 20 may be powered by a mobile power source such as, but not limited to, a battery or to a stationary power source.

Pump 20 may be used for pumping in (inflating) or pumping out (disinflation) various types of gases (such as air, oxygen etc.) or fluids (such as water, oil etc.).

Cloth fabric 20 may be used for various purposes, such as:

Protection,

Insulation,

Heat preservation/assertion,

Medical treatment, etc.

Pump 10 may be controlled by an ECU (Electronic Control Unit) that is a part of the pump or is an external device, so as to provide various profiles of inflation/disinflation as function of time. Such inflation/disinflation profiles may be a continuous (ramp) inflation and disinflation, pulsed inflation/disinflation, random inflation/disinflation, etc.

Cloth fabric 20 may have any desired precut form and dimensions, and may also include specifically designed open interconnection 18, made so as to fitly be connectable to an adjacent cloth fabric 10 thus allowing for the formation of multi patch fabric, constructed of plurality of cloth fabric 10 connected to each other, all being pumped by only one pump 20.

In another embodiment of the present invention a multi patch fabric may consist of plurality of cloth fabric 10 connected to each other so that each such cloth fabric 10 is being pumped by it's own, dedicated, pump 20.

Cloth fabric 10 may change its dimension or shape when being pumped as a result of the inflation/disinflation.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A cloth fabric comprising:
at least two layers of cloth placed on top of each other, said at least two layers of cloth being connected to each other along connecting lines so as to form airway between said layers and along the gaps between each pairs of adjacent connecting lines.

2. The cloth fabric of claim 1, wherein said connecting lines form serpentine airway.

3. The cloth fabric of claim 1, wherein said connecting lines form concentric continuous airway.

4. The cloth fabric of claim 1, wherein said connecting lines are formed by means of one of stitching or bonding or heat welding.

5. A cloth fabric comprising:
at least two layers of cloth placed on top of each other, said at least two layers of cloth being connected to each other along connecting lines so as to form airway between said layers and along the gaps between each pairs of adjacent connecting lines; and
a compressed gas source connected to one end of said airway to supply compressed gas into said airway.

6. The cloth fabric of claim 5, wherein said connecting lines form serpentine airway.

7. The cloth fabric of claim 5, wherein said connecting lines form concentric continuous airway.

8. The cloth fabric of claim 5, wherein said connecting lines are formed by means of one of stitching or bonding or heat welding.

9. A method of providing insulation to a body comprising:
providing to a body a cloth having at least two layers placed on top of each other and connected to each other along connecting lines to form at least one continuous airway between said connecting lines and said layers, and
providing compressed gas into said at least one airway.

10. The method of claim 9 wherein said step of providing compressed gas further comprising providing said gas in a pressure varying in time.

11. A garment comprising:
a plurality of cloths, wherein each of said plurality of cloths comprising at least two layers of cloth placed on top of each other, said at least two layers of cloth being connected to each other along connecting lines so as to form airway between said layers and along the gaps between each pairs of adjacent connecting lines; and
a compressed gas source connected to one end of said airway in each of said cloths to supply compressed gas into said airway.

12. The garment of claim 11, wherein said connecting lines form serpentine airway.

13. The garment of claim 11, wherein said connecting lines form concentric continuous airway.

14. The garment of claim 11, wherein said connecting lines are formed by means of one of stitching or bonding or heat welding.
